(19) United States
(12) Patent Application Publication
(10) Pub. No.: US 2025/0274911 A1
(43) Pub. Date: Aug. 28, 2025

(54) METHOD AND APPARATUS FOR INDICATING CHANNEL OCCUPANCY STRUCTURE OVER UNLICENSED SPECTRUM

(71) Applicant: LENOVO (BEIJING) LIMITED, Beijing (CN)

(72) Inventors: Haipeng Lei, Beijing (CN); Xiaodong Yu, Beijing (CN); Xin Guo, Beijing (CN); Zhennian Sun, Beijing (CN)

(21) Appl. No.: 18/857,960

(22) PCT Filed: Apr. 21, 2022
(86) PCT No.: PCT/CN2022/088170

§ 371 Date: Oct. 18, 2024

(51) Int. Cl. H04W 72/0446; H04L 1/1812; H04W 72/25

(52) U.S. Cl. CPC H04W 72/0446; H04L 1/1812; H04W 72/25

(57) ABSTRACT

Embodiments of the present disclosure relate to methods and apparatuses for sidelink transmission over an unlicensed spectrum. According to some embodiments of the disclosure, a UE may: perform a channel access procedure for initiating a COT; and transmit an SCI format within the COT in response to the channel access procedure being successful, wherein the SCI format may include structure information of the COT.

### TECHNICAL FIELD

Embodiments of the present disclosure generally relate to wireless communication technology, and more particularly to a sidelink transmission over an unlicensed spectrum.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication systems may support sidelink communications, in which devices (e.g., UEs) that are relatively close to each other may communicate with one another directly via a sidelink, rather than being linked through the BS. The term “sidelink” may refer to a radio link established for communicating among devices (e.g., UEs), as opposed to communicating via the cellular infrastructure (e.g., uplink and downlink). Sidelink transmission may be performed on a licensed spectrum and an unlicensed spectrum.

There is a need for handling sidelink transmissions on an unlicensed spectrum.

### SUMMARY

Some embodiments of the present disclosure provide a user equipment (UE). The UE may include: a transceiver; and a processor coupled to the transceiver. The processor may be configured to: perform a channel access procedure for initiating a channel occupancy time (COT); and transmit a sidelink control information (SCI) format in response to the channel access procedure being successful, wherein the SCI format comprises structure information of the COT.

In some embodiments of the present disclosure, the SCI format may include a COT structure indicator to indicate the structure information of the COT, and the COT structure indicator may indicate a slot format combination from a list of slot format combinations or indicates a COT structure from a list of COT structures.

In some embodiments of the present disclosure, each COT structure of the list of COT structures may indicate at least one of the following indicators with respect to a reference sub-carrier spacing (SCS): a first indicator indicating a number of consecutive slots occupied by the UE; a second indicator indicating a number of symbols used as a gap within the last slot occupied by the UE; a third indicator indicating a number of consecutive slots shared with a second UE; a fourth indicator indicating a number of symbols shared with the second UE within the last slot shared with the second UE; a fifth indicator indicating a number of symbols used as a gap between the end of the symbols shared with the second UE and the beginning of a first PSFCH unit of at least one PSFCH unit; a sixth indicator indicating a number of PSFCH units of the at least one PSFCH unit after the last symbol shared with the second UE; or a seventh indicator indicating the number of symbols after the last PSFCH unit of the at least one PSFCH unit.

In some embodiments, each of the at least one PSFCH unit may include a plurality of consecutive symbols for a PSFCH transmission and the first symbol of the plurality of consecutive symbols may be a repetition of the second symbol of the plurality of consecutive symbols.

In some embodiments, a gap may be between every two consecutive PSFCH units of the at least one PSFCH unit and have a duration based on the fifth indicator.

In some embodiments of the present disclosure, a bit size of the COT structure indicator may be based on the number of slot format combinations in the list of slot format combinations or the number of COT structures in the list of COT structures.

In some embodiments of the present disclosure, the list of slot format combinations or the list of COT structures may be configured by a serving base station (BS) or predefined.

Some embodiments of the present disclosure provide a user equipment (UE). The UE may include: a transceiver; and a processor coupled to the transceiver. The processor may be configured to: receive a first sidelink control information (SCI) format, wherein the first SCI format comprises structure information of a channel occupancy time (COT) initiated by a first UE; and perform a channel access procedure for a sidelink transmission within the COT based on the structure information.

In some embodiments of the present disclosure, the structure information of the COT may indicate at least one of the following: a first time domain resource reserved for a physical sidelink feedback channel (PSFCH) transmission, a second time domain resource occupied by the first UE, a third time domain resource for a gap, a fourth time domain resource shared with the UE or a second UE, or a fifth time domain resource for automatic gain control (AGC).

In some embodiments of the present disclosure, the processor may be further configured to receive a physical sidelink shared channel (PSSCH) from the first UE on the second time domain resource or from the second UE on the fourth time domain resource; and wherein performing a channel access procedure for a sidelink transmission may include performing a channel access procedure for transmitting a PSFCH on the first time domain resource carrying hybrid automatic repeat request acknowledge (HARQ-ACK) feedback corresponding to the PSSCH.

In some embodiments of the present disclosure, performing a channel access procedure for a sidelink transmission may include performing a channel access procedure for transmitting a physical sidelink control channel (PSCCH) and a physical sidelink shared channel (PSSCH) scheduled by the PSCCH on the fourth time domain resource. In some embodiments, the processor may be configured to transmit a second SCI format on the fourth time domain resource in response to the channel access procedure for the sidelink transmission being successful, wherein the second SCI format may indicate the structure information of the COT.

In some embodiments of the present disclosure, the first SCI format may be received within the COT according to a period, which may be configured by a serving base station (BS), the first UE, or predefined.

In some embodiments of the present disclosure, the first SCI format may include a COT structure indicator to indicate the structure information of the COT. The COT structure indicator may indicate a slot format combination from a list of slot format combinations or may indicate a COT structure from a list of COT structures.

In some embodiments, each slot format combination of the list of slot format combinations may include slot format information for one or more consecutive slots with respect to a reference sub-carrier spacing (SCS). In some embodiments, the slot format information for a slot may indicate a corresponding symbol state for each symbol of the slot and the corresponding symbol state may indicate at least one of the following: occupied by the first UE, reserved for a PSFCH transmission, used for a gap, shared with the UE or a second UE, or used for automatic gain control (AGC).

In some embodiments, each COT structure of the list of COT structures may include at least one of the following indicators with respect to a reference sub-carrier spacing (SCS): a first indicator indicating a number of consecutive slots occupied by the first UE; a second indicator indicating a number of symbols used as a gap within the last slot occupied by the first UE; a third indicator indicating a number of consecutive slots shared with the UE or a second UE; a fourth indicator indicating a number of symbols shared with the UE or the second UE within the last slot shared with the UE or the second UE; a fifth indicator indicating a number of symbols used as a gap between the end of the symbols shared with the UE or the second UE and the beginning of a first PSFCH unit of at least one PSFCH unit; a sixth indicator indicating a number of PSFCH units of the at least one PSFCH unit after the last symbol shared with the UE or the second UE; or a seventh indicator indicating the number of symbols after the last PSFCH unit of the at least one PSFCH unit.

In some embodiments, each of the at least one PSFCH unit may include a plurality of consecutive symbols for a PSFCH transmission and the first symbol of the plurality of consecutive symbols is a repetition of the second symbol of the plurality of consecutive symbols.

In some embodiments, a gap may be between every two consecutive PSFCH units of the at least one PSFCH unit and have a duration based on the fifth indicator.

In some embodiments, a bit size of the COT structure indicator may be based on the number of slot format combinations in the list of slot format combinations or the number of COT structures in the list of COT structures.

In some embodiments, the list of slot format combinations or the list of COT structures may be configured by a serving base station (BS) or predefined.

In some embodiments of the present disclosure, the structure information of the COT may be structure information of the whole COT, and the SCI format further may indicate a position of a slot where the SCI format is received with reference to a first slot of the COT; or wherein the structure information of the COT may be structure information of a remaining duration of the COT; or wherein the structure information of the COT may be structure information within a corresponding transmission periodicity of the SCI format. In some embodiments, the position may be indicated by a slot index of the slot where the SCI format is received with reference to the first slot of the COT, or the position may be indicated by a remaining duration of the COT.

Some embodiments of the present disclosure provide a method for wireless communication performed by a user equipment (UE). The method may include: performing a channel access procedure for initiating a channel occupancy time (COT); and transmitting a sidelink control information (SCI) format in response to the channel access procedure being successful, wherein the SCI format comprises structure information of the COT.

Some embodiments of the present disclosure provide a method for wireless communication performed by a user equipment (UE). The method may include: receiving a first sidelink control information (SCI) format, wherein the first SCI format comprises structure information of a channel occupancy time (COT) initiated by a first UE; and performing a channel access procedure for a sidelink transmission within the COT based on the structure information.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates an exemplary UE-initiated COT structure in accordance with some embodiments of the present disclosure;

FIGS. 3-4 illustrate a flow chart of an exemplary procedure of sidelink communication over an unlicensed spectrum in accordance with some embodiments of the present disclosure; and

FIG. 5 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

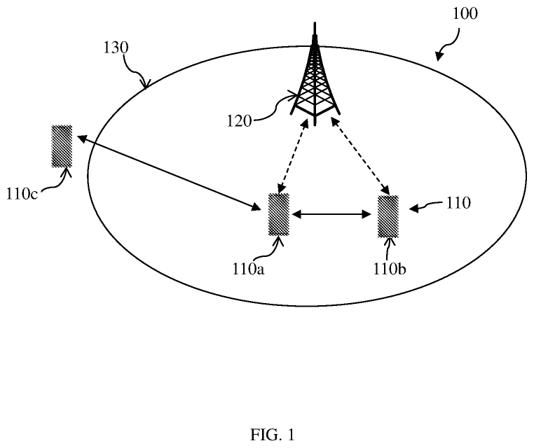

FIG. 1 illustrates a schematic diagram of a wireless communication system 100 in accordance with some embodiments of the present disclosure.

As shown in FIG. 1, a wireless communication system 100 may include a base station (e.g., BS 120) and some UEs 110 (e.g., UE 110a, UE 110b, and UE 110c). Although a specific number of UEs 110 and one BS 120 are depicted in FIG. 1, it is contemplated that any number of BSs and UEs in and outside of the coverage of the BSs may be included in the wireless communication system 100.

In some embodiments of the present disclosure, BS 120 may be referred to as an access point, an access terminal, a base, a base unit, a macro cell, a Node-B, an evolved Node B (eNB), a gNB, a Home Node-B, a relay node, or a device, or described using other terminology used in the art. BS 120 is generally a part of a radio access network that may include one or more controllers communicably coupled to one or more corresponding BSs. BS 120 may communicate with UE(s) 110 via downlink (DL) communication signals.

UE(s) 110 (e.g., UE 110a, UE 110b, or UE 110c) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE(s) 110 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE(s) 110 includes wearable devices, such as smart watches, fitness bands, optical head-mounted displays, or the like. Moreover, UE(s) 110 may be referred to as a subscriber unit, a mobile, a mobile station, a user, a terminal, a mobile terminal, a wireless terminal, a fixed terminal, a subscriber station, a user terminal, an IoT device, a vehicle, or a device, or described using other terminology used in the art. UE(s) 110 may communicate with BS 120 via uplink (UL) communication signals.

Wireless communication system 100 may be compatible with any type of network that is capable of sending and receiving wireless communication signals. For example, wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, wireless communication system 100 is compatible with 5G NR of the 3GPP protocol. For example, BS 120 may transmit data using an orthogonal frequency division multiple (OFDM) modulation scheme on the DL and UE(s) 110 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS 120 and UE(s) 110 may communicate using other communication protocols, such as the IEEE 802.11 family of wireless communication protocols. Further, in some embodiments of the present disclosure, BS 120 and UE(s) 110 may communicate over licensed spectrums, whereas in some other embodiments, BS 120 and UE(s) 110 may communicate over unlicensed spectrums. The present disclosure is not intended to be limited to the implementation of any particular wireless communication system architecture or protocol.

BS 120 may define one or more cells, and each cell may have a coverage area 130. In the exemplary wireless communication system 100, some UEs (e.g., UE 110a and UE 110b) are within the coverage of BS 120, which may not be the specific BS 120 as shown in FIG. 1 and can be any one of the BSs 120 in a wireless communication system, and some UEs (e.g., UE 110c) are outside of the coverage of BS 120. For example, in the case that the wireless communication system includes two BSs 120 with UE 110a being within the coverage of any one of the two BSs means that UE 110a is within the coverage of a BS 120 (i.e., in-coverage) in the wireless communication system; and UE 110a being outside of the coverage of both BSs 120 means that UE 110a is outside the coverage of a BS 120 (i.e., out-of-coverage) in the wireless communication system.

Still referring to FIG. 1, UE 110a and UE 110b may communicate with BS 120 via, for example, a Uu link (denoted by dotted arrow in FIG. 1). UE 110a, UE 110b, and UE 110c may communicate with each other via a sidelink (denoted by solid arrow in FIG. 1).

Sidelink transmission may involve a physical sidelink control channel (PSCCH) and an associated physical sidelink shared channel (PSSCH), which may be scheduled by the sidelink control information (SCI) carried on the PSCCH. The SCI and associated PSSCH may be transmitted from a transmitting UE (hereinafter referred to as “Tx UE”) to a receiving UE (hereinafter referred to as “Rx UE”) in a unicast manner, to a group of Rx UEs in a groupcast manner, or to Rx UEs within a range in a broadcast manner. For example, referring to FIG. 1, UE 110a (acting as a Tx UE) may transmit data to UE 110b or UE 110c (acting as an Rx UE).

The PSSCH may carry data which may require corresponding HARQ-ACK feedback from the Rx UE(s) to the Tx UE. In some examples, the broadcast transmission may not need HARQ-ACK feedback. In some examples, unicast and groupcast transmissions may enable HARQ-ACK feedback under certain preconditions. The HARQ-ACK feedback for a PSSCH may be carried on a physical sidelink feedback channel (PSFCH).

In some embodiments of the present disclosure, sidelink transmission may be performed on an unlicensed spectrum. When an unlicensed spectrum is used for sidelink transmissions, a channel access procedure (also known as a listen-before-talk (LBT) test or LBT procedure) is required before any sidelink transmission. An LBT procedure may be performed based on energy detection in each sensing slot. For example, when the detected energy on a channel in a sensing slot is lower than the energy detection threshold, then the channel is deemed as empty or clear or available in that sensing slot; otherwise, the channel is deemed as occupied or non-available in that sensing slot.

Two types of channel access procedures, i.e., channel access Type 1 and channel access Type 2 are supported. For channel access Type 1 (also known as LBT Cat.4), usually, the energy detection needs to be performed in a range from several sensing slots to hundreds of sensing slots. A random backoff counter may be selected from a contention window (CW) if the initial energy detection fails. The random backoff counter may be decremented by 1 if a sensing slot is deemed as empty. As long as the random backoff counter counts down to zero, the channel can be regarded as available and the transmission can be started. In LBT Cat.4, the contention window may be continuously updated based on the HARQ-ACK feedback from the receiver. As a result, LBT Cat.4 may cause an unpredictable sensing time. For channel access Type 2 (also known as LBT Cat.2), usually one-shot sensing is performed within, for example, a 16 us sensing interval or within at least 25 us sensing interval. Based on the one-shot sensing, if the channel is deemed as empty then the transmission can get started; otherwise, the transmission fails. As a result, compared to channel access Type 1, channel access Type 2 is relatively simpler and faster to grab the channel.

For an unlicensed spectrum, by performing channel access Type 1, a UE can obtain a channel occupancy (CO) and occupy the channel until the maximum channel occupancy time (MCOT). For example, as shown in below Table 1, the MCOT may be related to a channel access priority class (CAPC) value. It should be understood that Table 1 is only for illustrative purposes, and should not be construed as limiting the embodiments of the present disclosure.

TABLE 1
Channel Access Priority Class VS MCOT (T_{ulmcot, p})

| Channel | | | | | |
|---|---|---|---|---|---|
| Access | | | | | |
| Priority | | | | | allowed |
| Class (p) | mₚ | CW_{min, p} | CW_{max, p} | T_{ulmcot, p} | CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 ms | {15, 31, 63, |
| | | | | | 127, 255, 511, |
| | | | | | 1023} |
| 4 | 7 | 15 | 1023 | 6 ms or 10 ms | {15, 31, 63, |
| | | | | | 127, 255, 511, |
| | | | | | 1023} |

NOTE 1:
For p = 3, 4, T_{ulmcot, p} = 10 ms if the higher layer parameter ‘absenceOfAnyOtherTechnology-r14’ indicates TRUE, otherwise, T_{ulmcot, p} = 6 ms.
NOTE 2:
When T_{ulmcot, p} = 6 ms, it may be increased to 8 ms by inserting one or more gaps. The minimum duration of a gap shall be 100 μs. The maximum duration before including any such gap shall be 6 ms.

According to the above table, when a UE performs a successful channel access Type 1, the UE can occupy the channel at a maximum of 2 ms, 4 ms, 6 ms or 10 ms, depending on the corresponding CAPC value which is determined based on the traffic priority. The higher the CAPC value is, the longer the MCOT on the unlicensed spectrum is. As shown in the above table, for CAPC value of 3 or 4, the MCOT can be 10 ms, which is equivalent to 10 slots in the case of 15 kHz subcarrier spacing, 20 slots in the case of 30 kHz subcarrier spacing, 40 slots in the case of 60 kHz subcarrier spacing, or 80 slots in the case of 120 kHz subcarrier spacing.

Consequently, when a UE (denoted as UE #1 for simplicity) performs a successful channel access Type 1 for unicast communication with another UE (denoted as UE #2 for simplicity), UE #1 can occupy the channel at a maximum of 2 ms, 4 ms, 6 ms or 10 ms. When UE #1 starts the sidelink transmission to UE #2, UE #1 may transmit a PSCCH or a PSSCH in multiple consecutive slots without any transmission gap so as to avoid the risk of losing the channel. From UE #2's point of view, it may not have the information for how many remaining consecutive slots UE #1 will use to transmit sidelink data to it. If UE #2 switches its operating mode from Rx to Tx for transmitting sidelink data/control to other UEs before UE #1 stops transmission, UE #2 may miss the transmissions from UE #1. When UE #2 is requested to transmit a PSFCH(s) corresponding to the received sidelink data, since UE #1 cannot receive the PSFCH feedback from UE #2 corresponding to the missed sidelink transmissions, UE #1 has to perform a new channel access procedure (e.g., channel access Type 1) for retransmitting the missed sidelink data. When UE #2 is not requested to send a PSFCH(s) corresponding to the received sidelink data, UE #1 cannot determine whether its transmitted sidelink data is missed by UE #2 or not so that UE #1 may not retransmit the missed sidelink data. As a result, some sidelink data may lose the retransmission opportunity.

When the unlicensed spectrum is used for sidelink transmission, the channel access procedure is required before any sidelink transmission. It would be beneficial if a Tx UE initiated COT can be shared to one or more Rx UEs. Embodiments of the present disclosure provide solutions to share the COT. For example, a Tx UE initiated COT may be shared with one or more other UEs for transmitting a PSCCH, PSSCH, PSFCH or any combination thereof. More details on the embodiments of the present disclosure will be illustrated in the following text in combination with the appended drawings.

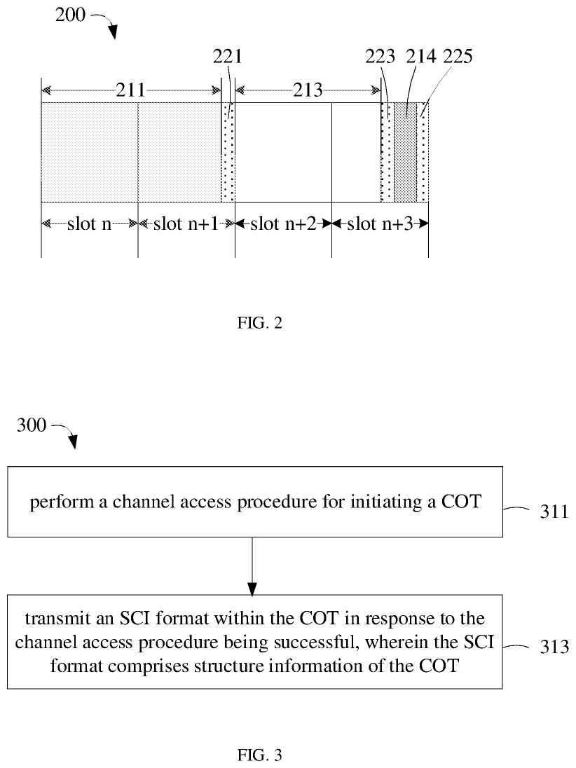

FIG. 2 shows an exemplary UE-initiated COT 200 structure in accordance with some embodiments of the present disclosure.

Referring to FIG. 2, after initiating a COT (e.g., COT 200 in FIG. 2) by performing a Type 1 channel access procedure, a Tx UE (denoted as UE #1A for simplicity) may perform contiguous sidelink transmissions without any gap in time domain. For example, UE #1A may transmit a PSCCH(s) and a PSSCH(s) to an Rx UE (denoted as UE #2A for simplicity) on time domain resource 211 in slot n and slot n+1 as show in FIG. 2. The PSSCH(s) may be scheduled by the PSCCH(s) (e.g., SCI).

UE #1A may share some resources (e.g., time domain resource 213) within COT 200 with a different UE(s) (e.g., UE #2A and/or any other UEs) for transmitting, for example, a PSCCH(s) and associated PSSCH(s). In some examples, at least one symbol may be used as a gap between two consecutive sidelink transmissions (e.g., PSSCHs). For example, gap 221 may be arranged between time domain resource 211 and time domain resource 213.

COT 200 may also include a PSFCH transmission occasion(s) especially when HARQ-ACK feedback is enabled. For example, COT 200 may include time domain resource 214 for UE #2A transmitting HARQ-ACK feedback to UE #1A. At least one symbol may be used as a gap before and/or after a PSFCH transmission. For example, gap 223 and gap 225 may be arranged before and after time domain resource 214.

The structures of gaps 221, 223, and 225 may be the same or different. For example, gaps 221, 223, and 225 may include the same or different numbers of symbols.

It should be understood that the COT structure in FIG. 2 is only for illustrative purposes, and should not be construed as limiting the embodiments of the present disclosure. For example, in some other embodiments of the present disclosure, a COT initiated by UE #1A may include a time domain resource for automatic gain control (AGC).

When an Rx UE (e.g., UE #2A and/or any other UEs) intends to utilize a Tx UE initiated COT (e.g., COT 200) for a sidelink transmission (e.g., PSCCH, PSSCH, PSFCH, or any combination thereof), the Rx UE should be aware of the structure of the COT.

In some embodiments of the present disclosure, after a Tx UE initiates a COT on an unlicensed spectrum (e.g., by performing LBT Cat.4), the Tx UE can transmit a PSCCH(s) and PSSCH(s) in each slot of the COT without exceeding the MCOT. In some embodiments of the present disclosure, COT structure information may be included in an SCI format transmitted by the Tx UE. Such an SCI format may or may not schedule a PSSCH(s).

In some embodiments, the SCI format including the COT structure information may be transmitted according to a period within the COT. The period may be configured by a serving BS or the Tx UE or predefined, for example, in a standard(s). For example, the SCI format may be transmitted in every slot or every N slots. N may be configured by RRC signaling or predefined according to the CAPC used for initiating the COT or the number of slots contained in the MCOT. For example, N=1 for CAPC=1 or 2, and N=2 for CAPC=3 or 4. For example, N=1 for no more than 4 slots within the MCOT, N=2 for 8 or more slots within the MCOT, and N=4 for 16 or more slots within the MCOT.

In some embodiments, the COT structure information may indicate at least one of the following: a time domain resource reserved for a PSFCH transmission (denoted as resource #1), a time domain resource occupied by the UE, a time domain resource for a gap, a time domain resource shared with another UE (denoted as resource #2), or a time domain resource for AGC. For example, the COT structure information may indicate at least one of: the positions of the resources occupied by the UE initiating the COT, the gap symbols, the PSFCHs, the shared resources, and the AGC symbols. A channel access procedure may be performed before a UE uses resource #1 or resource #2. The channel access procedure may be channel access Type 2.

In some embodiments of the present disclosure, the COT structure information may be indicated to Rx UEs by indicating the format of each slot within the COT.

Regarding the slot format, in some embodiments, each symbol of a slot can have one of at least the following states:
state #1, indicating that the symbol is occupied by the Tx UE which initiates the COT for sidelink transmissions (e.g., PSCCH, PSSCH or both);
state #2, indicating that the symbol is reserved for a PSFCH transmission (e.g., used by one or more Rx UEs for transmitting a PSFCH corresponding to a PSSCH transmitted by the Tx UE or corresponding to a PSSCH transmitted by other UEs using the shared resource);
state #3, indicating that the symbol is used as gap, which can be used for operating mode switch (e.g., from Rx to Tx or from Tx to Rx) or for performing an LBT, or can be left blank in the case that, for example, the last slot within the COT is a partial slot with only first several symbols available for sidelink transmissions so as not to exceed the MCOT; and
state #4, indicating that the symbol is not used by the Tx UE and can be shared with other UEs for sidelink transmissions (e.g., PSCCH, PSSCH or both), for example, the Tx UE shares the symbol with other UEs as UE-to-UE COT sharing.

In some embodiments, each symbol of a slot can have one of at least the following states:
state #1-state #4; and
state #5, indicating that the symbol is used as an AGC symbol, for example, the symbol is a repetition of the next symbol.

In some examples, state #5 may not be needed if, for example, the position of an AGC symbol is predefined in a standard(s). For example, an AGC symbol may be always located in the first symbol of a COT, always in the first symbol of each slot within a COT, always in the first symbol of each PSCCH, always in the first symbol of each PSSCH, always in the symbol immediately before the PSFCH symbol, or any combination thereof.

Table 2 below shows exemplary slot formats for a slot within a UE initiated COT. For clarity, “O”, “F”, “G”, “S”, and “A” in Table 2 correspond to state #1-state #5, respectively. It should be understood that Table 2 is only for illustrative purposes, and should not be construed as limiting the embodiments of the present disclosure.

TABLE 2
Exemplary slot format for a slot within a UE initiated COT

| Slot | | | | | | | | | | | | | | |
|---|---|---|---|---|---|---|---|---|---|---|---|---|---|---|
| Format | Symbol index within a slot | | | | | | | | | | | | | |
| index | 0 | 1 | 2 | 3 | 4 | 5 | 6 | 7 | 8 | 9 | 10 | 11 | 12 | 13 |
| 0 | O | O | O | O | O | O | O | O | O | O | O | O | O | O |
| 1 | O | O | O | O | O | O | O | O | O | O | O | O | O | G |
| 2 | O | O | O | O | O | O | O | O | O | O | O | O | G | G |
| 3 | O | O | O | O | O | O | O | O | O | O | O | G | G | G |
| 4 | O | O | O | O | O | O | O | O | O | O | G | G | G | G |
| 5 | O | O | O | O | O | O | O | O | O | O | G | F | F | G |
| 6 | O | O | O | O | O | O | O | G | F | F | G | F | F | G |
| 7 | O | O | O | O | G | F | F | G | F | F | G | F | F | G |
| 8 | G | G | F | F | G | F | F | G | F | F | G | F | F | G |
| 9 | G | F | F | G | F | F | G | F | F | G | F | F | G | G |
| 10 | S | S | S | S | S | S | S | S | S | S | S | S | S | S |
| 11 | S | S | S | S | S | S | S | S | S | S | S | S | S | G |
| 12 | S | S | S | S | S | S | S | S | S | S | S | S | G | G |
| 13 | S | S | S | S | S | S | S | S | S | S | S | G | G | G |
| 14 | S | S | S | S | S | S | S | S | S | S | G | G | G | G |
| 15 | S | S | S | S | S | S | S | S | S | S | G | F | F | G |
| 16 | S | S | S | S | S | S | S | G | F | F | G | F | F | G |
| 17 | S | S | S | S | G | F | F | G | F | F | G | F | F | G |
| 18 | A | O | O | O | O | O | O | O | O | O | O | O | O | O |
| 19 | A | O | O | O | O | O | O | O | O | O | O | O | O | G |
| 20 | A | O | O | O | O | O | O | O | O | O | G | A/F | F | G |
| 21 | O | O | O | O | O | O | O | O | O | O | O | G | F | F |
| 22 | O | O | O | O | O | O | O | O | G | F | F | G | F | F |
| 23 | O | O | O | O | O | G | F | F | G | F | F | G | F | F |
| 24 | O | O | G | F | F | G | F | F | G | F | F | G | F | F |
| 25 | F | F | G | F | F | G | F | F | G | F | F | G | F | F |
| 26 | S | S | S | S | S | S | S | S | S | S | S | G | F | F |
| 27 | S | S | S | S | S | S | S | S | G | F | F | G | F | F |
| 28 | S | S | S | S | S | G | F | F | G | F | F | G | F | F |
| 29 | S | S | G | F | F | G | F | F | G | F | F | G | F | F |

According to Table 2 above, slot format 0 (i.e., slot format index=0) indicates that the whole slot is occupied by the UE initiating the COT.

Each of slot formats 1, 2, 3 and 4 indicates that a first part of the slot is occupied by the UE initiating the COT and a second part comprising the last 1, 2, 3 or 4 symbols is left as a gap. The gap symbol(s) can be used for operating mode switch (e.g., from Rx to Tx or from Tx to Rx), used for performing an LBT, or blanked due to the restriction of the MCOT. More symbols may be needed as a gap, for example, in the case of relatively larger subcarrier spacing or blanked due to the restriction of the MCOT, which are not listed here. In some examples, the gap immediately following the last PSSCH within the COT may not be necessarily listed in the slot formats, or named as reserved symbol. Such slot formats are not listed here.

Each of slot formats 5, 6, and 7 indicates that a first part of the slot is occupied by the UE initiating the COT and a second part of the slot is used by an Rx UE(s) for transmitting a PSFCH(s) with a gap symbol before each PSFCH and after each PSFCH. Other PSFCH positions or more gap symbols between two consecutive PSFCHs may be possible and are not listed here. In some examples, the gap immediately following the last PSFCH within the COT may not be necessary so that one additional symbol can be used for PSSCH transmission. For example, as shown in slot format 21, 22, 23 and 24, symbol 13 is occupied by the last PSFCH within the COT.

Each of slot formats 8 and 9 indicates that the whole slot is used for transmitting PSFCHs with one or two symbols (as a gap) at the end or beginning of the slot. Other PSFCH positions or more gap symbols between two consecutive PSFCHs may be possible and are not listed here. In some examples, the gap immediately following the last PSFCH within the COT may not be necessary so that one additional symbol can be used for PSFCH transmission. For example, as shown in slot format 25, symbol 13 is occupied by the last PSFCH within the COT so there are 5 PSFCH transmission occasions within one slot.

Slot format index 10 indicates that the whole slot is not occupied by the UE initiating the COT and can be shared with other UEs for sidelink transmissions (e.g., PSCCH, PSSCH or both).

Each of slot formats 11, 12, 13 and 14 indicates that a first part of the slot is not occupied by the UE initiating the COT and can be shared with other UEs and a second part comprising the last 1, 2, 3 or 4 symbols is left as a gap. The gap symbol(s) can be used for operating mode switch (e.g., from Rx to Tx or from Tx to Rx), used for performing an LBT, or blanked due to the restriction of the MCOT. More symbols may be needed as a gap, which are not listed here. In some examples, the gap immediately following the last PSSCH within the COT may not be necessarily listed in the slot formats, or named as reserved symbol. Such slot formats are not listed here.

Each of slot formats 15, 16, and 17 indicates that a first part of the slot is not occupied by the UE initiating the COT and can be shared with other UEs and a second part of the slot is used by an Rx UE(s) for transmitting a PSFCH(s) with a gap symbol before each PSFCH and after each PSFCH. Other PSFCH positions or more gap symbols between two consecutive PSFCHs may be possible and are not listed here. In some examples, the gap immediately following the last PSFCH within the COT may not be necessary so that one additional symbol can be used for PSSCH transmission. For example, as shown in slot format 26, 27, 28 and 29, symbol 13 is occupied by the last PSFCH within the COT.

Each of slot formats 18, 19 and 20 indicates that one AGC symbol is used in the first symbol of the slot. Slot format 20 further indicates that one AGC symbol can be used in the first PSFCH symbol of two consecutive PSFCH symbols. Other AGC positions or more gap symbols between two consecutive PSFCHs may be possible and are not listed here.

In some embodiments, a list of slot format combinations may be configured by RRC signaling or predefined, for example, in a standard(s). Each slot format combination may include slot format information for one or multiple consecutive slots. The structure of a UE initiated COT can be indicated by a specific slot format combination from the list of slot format combinations. For example, an SCI format may include a COT structure indicator, which indicates a slot format combination from the list of slot format combinations, to indicate the COT structure information. The number of required bits (e.g., the bit size) for the COT structure indicator may be determined based on the number of slot format combinations in the list of slot format combinations.

The configuration of the indicated slot format combination may consider at least one of the following: the transmission periodicity of the SCI format indicating the COT structure information, the duration of the MCOT, the maximum number of slots within the MCOT, the processing capability for PSFCH transmission (e.g., UE's processing capability for setting a PSFCH location), the duration of the shared resources, or the number of symbols within a gap.

In some embodiments, the number of slots within the MCOT may be an integer multiple of number of slots within the indicated slot format combination. In some embodiments, the number of slots within the MCOT may be an integer multiple of number of slots within each slot format combination in the list of slot format combinations. In some embodiments, the number of slots within one slot format combination may be set equal to the transmission periodicity of the SCI format indicating the COT structure information. In some embodiments, the COT structure information may be used to indicate the COT structure information only for the slots within the corresponding periodicity. For example, assuming that the transmission periodicity of the SCI format indicating COT structure information is 4 slots, the corresponding COT structure information indicates the COT structure for the following 4 slots, e.g., an SCI transmitted in slot n indicates the COT structure information for slot n. n+1, n+2 and n+3, and an SCI transmitted in slot n+4 indicates the COT structure information for slot n+4, n+5, n+6 and n+7.

In some embodiments, a reference subcarrier spacing (SCS) is required when configuring or defining the list of slot format combinations. This is because the duration of a slot is relevant to the SCS. For example, each slot format combination of the list of slot format combinations may be configured or defined with respect to a reference SCS. When the subcarrier spacing of current sidelink bandwidth part (BWP) is equal to the reference subcarrier spacing, then Rx UEs just follow the indicated COT structure information due to the same duration of one slot as that in the indicated slot format combination. When the subcarrier spacing of current sidelink BWP is larger than the reference subcarrier spacing, e.g., assuming that the reference subcarrier spacing is represented as 2^{m}. 15 [kHz] and the current subcarrier spacing is represented as 2ⁿ. 15 [kHz], men, then Rx UEs understand that each slot within the indicated COT structure information is applicable to consecutive sious.

$$\frac{{2}^{n}}{{2}^{m}}$$

When the subcarrier spacing of current sidelink channel is smaller than the reference subcarrier spacing, e.g., assuming that the reference subcarrier spacing is represented as 2^{m}·15 [kHz] and the current subcarrier spacing is represented as 2ⁿ·15 [KHz], m>n, then Rx UEs understand that each slot within the indicated COT structure information is applicable to one slot of current sidelink BWP, similar to the case when the subcarrier spacing of current sidelink BWP is equal to the reference subcarrier spacing.

Table 3 below shows an exemplary list of slot format combinations. Slot format x in Table 3 can refer to the exemplary slot format as shown in Table 2. For example, slot format 0 in Table 3 may refer to the slot format with slot format index 0 in Table 2. It should be understood that Table 3 is only for illustrative purposes, and should not be construed as limiting the embodiments of the present disclosure.

TABLE 3
Exemplary list of slot format combinations

| Slot format | | COT |
|---|---|---|
| combination | Slot format | duration |
| Index | combination | (opt.) |
| 0 | slot format 0 + slot format 1 | 2 ms |
| 1 | slot format 0 + slot format 0 + slot format 0 + | 4 ms |
| | slot format 5 | |
| 2 | slot format 0 + slot format 1 + | 4 ms |
| | slot format 10 + slot format 15 | |
| 3 | slot format 0 + slot format 0 + slot format 0 + | 8 ms |
| | slot format 1 + slot format 10 + slot format 10 + | |
| | slot format 10 + slot format 16 | |

In some examples, Table 3 may be configured or defined with a reference SCS of 15 kHz. Since there are 4 entries in Table 3, at least 2 bits ([log 2 (4)]) may be needed as the COT structure indicator.

Referring again to FIG. 2, where a UE initiates COT 200 with a COT duration from slot n to slot n+3, the structure of COT 200 can be represented as slot format 0+ slot format 1+ slot format 10+ slot format 15. According to the list of slot format combinations in Table 3, slot format combination 2 (index=2) is appropriate for the structure of COT 200. The COT structure indicator in an SCI format transmitted by the UE initiating COT 200 can indicate slot format combination 2.

Table 4 below shows another exemplary list of slot format combinations. Slot format x in Table 4 can refer to the exemplary slot format as shown in Table 2. For example, slot format 0 in Table 4 may refer to the slot format with slot format index 0 in Table 2. Table 4 may be configured or defined with a reference SCS of 15 kHz. It should be understood that Table 4 is only for illustrative purposes, and should not be construed as limiting the embodiments of the present disclosure.

TABLE 4
Exemplary list of slot format combinations

| Slot format | |
|---|---|
| combination | |
| Index | Slot format combination |
| 0 | slot format 0 + slot format 1 |
| 1 | slot format 0 + slot format 0 + slot format 0 + slot format 5 |
| 2 | slot format 0 + slot format 1 + slot format 10 + |
| | slot format 15 |
| 3 | slot format 0 + slot format 0 + slot format 0 + |
| | slot format 1 + slot format 10 + slot format 10 + |
| | slot format 10 + slot format 16 |
| 4 | slot format 1 + slot format 10 + slot format 15 |
| 5 | slot format 10 + slot format 15 |
| 6 | slot format 15 |

In some embodiments of the present disclosure, a list of COT structures may be configured by RRC signaling or predefined, for example, in a standard(s). Each COT structure may include at least one of the following parts or indicators:
part X1, indicating the number of consecutive slots occupied by the UE initiating the COT;
part X2, indicating the number of symbols used as a gap within the last slot occupied by the UE initiating the COT;
part X3, indicating the number of consecutive slots shared with other UEs (these slots may also be referred to as shared slots or shared resource);
part X4, indicating the number of symbols shared with other UEs within the last shared slot;
part X5, indicating the number of symbols used as a gap between the end of the symbols shared with other UEs and the beginning of a first PSFCH unit of at least one PSFCH unit within the COT;
part X6, indicating the number of PSFCH units of the at least one PSFCH unit after the last symbol shared with other UEs; or part X7, indicating the number of symbols after the last PSFCH unit of the at least one PSFCH unit.

Each PSFCH unit may include a plurality of (e.g., two) consecutive symbols for a PSFCH transmission. In some examples, the first symbol of the plurality of consecutive symbols in a PSFCH unit may be used for AGC. For example, the first symbol of the plurality of consecutive symbols in a PSFCH unit may be a repetition of the second symbol of the plurality of consecutive symbols. In some examples, a gap may exist between two consecutive PSFCH units. The duration of such gap may be based on X5. For example, the number of symbols for the gap may equal X5. In some examples, a gap may exist between the end of the last PSSCH and the beginning of a PSFCH. The duration of such gap may be based on X5. For example, the number of symbols for the gap may equal X5. Based on the number of symbols reserved for a PSFCH, a UE can determine the position of the PSFCH as well as a gap.

The structure of a UE initiated COT can be indicated by a specific COT structure from the list of COT structures. For example, an SCI format may include a COT structure indicator, which indicates a COT structure from the list of COT structures, to indicate the COT structure information. The number of required bits (e.g., the bit size) for the COT structure indicator may be determined based on the number of COT structures in the list of COT structures.

The configuration of the indicated COT structure may consider at least one of the following: the transmission periodicity of the SCI format indicating COT structure information, the duration of the MCOT, the maximum number of slots within the MCOT, the processing capability for PSFCH transmission (e.g., UE's processing capability for setting a PSFCH location), the duration of the shared resources, or the number of symbols within a gap.

In some embodiments, the number of slots within the MCOT may be an integer multiple of number of slots within the indicated COT structure. In some embodiments, the number of slots within the MCOT may be an integer multiple of number of slots within each COT structure in the list of COT structures. In some embodiments, the number of slots within one COT structure n may be set equal to the transmission periodicity of the SCI format indicating the COT structure information. In some embodiments, the COT structure information may be used to indicate the COT structure information only for the slots within the corresponding periodicity. For example, assuming that the transmission periodicity of the SCI format indicating COT structure information is 4 slots, the corresponding COT structure information indicates the COT structure for the following 4 slots, e.g., an SCI transmitted in slot n indicates the COT structure information for slot n, n+1, n+2 and n+3, and an SCI transmitted in slot n+4 indicates the COT structure information for slot n+4, n+5, n+6 and n+7.

In some embodiments, a reference subcarrier spacing (SCS) is required when configuring or defining the list of COT structures. This is because the duration of a slot is relevant to the SCS. For example, each COT structure of the list of COT structures may be configured or defined with respect to a reference SCS. When the subcarrier spacing of current sidelink bandwidth part (BWP) is equal to the reference subcarrier spacing, then Rx UEs just follow the indicated COT structure information due to the same duration of one slot as that in the indicated slot format combination. When the subcarrier spacing of current sidelink BWP is larger than the reference subcarrier spacing, e.g., assuming that the reference subcarrier spacing is represented as 2^{m}·15 [KHz] and the current subcarrier spacing is represented as 2ⁿ ·15 [kHz], m<n, then Rx UEs understand each slot within the indicated COT structure information is applicable to

$$\frac{{2}^{n}}{{2}^{m}}$$

consecutive slots. When the subcarrier spacing of current sidelink channel is smaller than the reference subcarrier spacing, e.g., assuming that the reference subcarrier spacing is represented as 2^{m}. 15 [kHz] and the current subcarrier spacing is represented as 2^{n. 15 [kHz], m>n, then Rx UEs understand that each slot within the indicated COT structure information is applicable to one slot of current sidelink BWP, similar to the case when the subcarrier spacing of current sidelink BWP is equal to the reference subcarrier spacing.}

Table 5 below shows an exemplary list of COT structures. It should be understood that Table 5 is only for illustrative purposes, and should not be construed as limiting the embodiments of the present disclosure.

TABLE 5
Exemplary list of COT structures

| index | COT structure |
|---|---|
| 0 | X1 = 2, X2 = 1, X3 = 0, X4 = 0, X5 = 0, X6 = 0, X7 = 0 |
| 1 | X1 = 4, X2 = 1, X3 = 0, X4 = 10, X5 = 1, X6 = 1, X7 = 1 |
| 2 | X1 = 2, X2 = 1, X3 = 2, X4 = 10, X5 = 1, X6 = 1, X7 = 1 |
| 3 | X1 = 2, X2 = 1, X3 = 2, X4 = 7, X5 = 1, X6 = 2, X7 = 1 |

In some examples, Table 5 may be configured or defined with a reference SCS of 15 kHz. Since there are 4 entries in Table 5, at least 2 bits ([log₂(4)]) may be needed as the COT structure indicator.

Referring again to FIG. 2, where a UE initiates COT 200 with a COT duration from slot n to slot n+3, the structure of COT 200 can be represented as: 2 consecutive slots occupied by the UE initiating the COT+one symbol gap+2 consecutive slots shared for other UEs+10 symbols shared in the last shared slot+1 symbol gap+one PSFCH unit+1 symbol gap. According to the list of COT structures in Table 5, COT structure 2 (index=2) is appropriate for the structure of COT 200. The COT structure indicator in an SCI format transmitted by the UE initiating COT 200 can indicate COT structure 2.

The COT structure information indicated in an SCI format may be the structure information of the whole COT, the structure information of the remaining duration of the COT, or the structure information of the current transmission periodicity for monitoring the SCI format indicating the COT structure information.

For example, in some embodiments, assuming that slot k is the first slot within a COT and M is the number of slots within the MCOT, the COT structure information may indicate slot format information for slot k, k+1, . . . , k+M-1 (e.g., by a corresponding SCI format combination or a corresponding COT structure). The same COT structure information may be transmitted in every transmission occasion of the SCI format.

For instance, referring again to FIG. 2, assuming that the COT structure information is transmitted in every slot and Table 3 is configured for a COT structure indication, slot format combination 2 may be transmitted in each slot within the COT.

For the shared resource, the same COT structure information can be transmitted by another UE which shares the COT. For example, referring to FIG. 2, if UE #2A uses slot n+2 for transmitting a PSCCH and a PSSCH, UE #2A may transmit slot format combination 2 in slot n+2.

The SCI format may further indicate a position of the current slot (i.e., where the SCI format is transmitted or received) with reference to the first slot (e.g., slot k) of the COT. In an example, the SCI format may indicate a slot index (e.g., slot level offset) with reference to the first slot of the COT. In another example, the SCI format may indicate the remaining duration (e.g., remaining slot(s)) of the COT. For example, when an SCI format is transmitted in slot k+1, the SCI format may indicate a slot index of 1 or indicate a remaining duration of M-1 (including the current slot) or a remaining duration of M-2 (excluding the current slot).

For example, in some embodiments, the COT structure information may indicate the structure information of the remaining duration of the COT and may be changed from one occasion to next within the COT.

For instance, referring again to FIG. 2, assuming that the COT structure information is transmitted in every slot and Table 4 is configured for a COT structure indication, slot format combination 2 may be transmitted in slot n to indicate the slot formats of slot n to slot n+3, slot format combination 4 may be transmitted in slot n+1 to indicate the slot formats of slot n+1 to slot n+3, slot format combination 5 may be transmitted in slot n+2 to indicate the slot formats of slot n+2 to slot n+3, and slot format combination 6 may be transmitted in slot n+3 to indicate the slot formats of slot n+3.

For the shared resource, consistent COT structure information should be transmitted by another UE which shares the COT. For example, referring to FIG. 2, if UE #2A uses slot n+2 for transmitting a PSCCH and a PSSCH, UE #2A may transmit slot format combination 5.

For example, in some embodiments, the COT structure information may indicate the structure information only for the slots within the corresponding transmission periodicity of the SCI format indicating the COT structure information, and may be changed from one transmission period to next within the COT.

For instance, referring again to FIG. 2, assuming that the COT structure information is transmitted in every 2 slots and Table 4 is configured for a COT structure indication, slot format combination 0 may be transmitted in slot n to indicate the slot formats of slot n to slot n+1, slot format combination 5 may be transmitted in slot n+2 to indicate the slot formats of slot n+2 to slot n+3.

For the shared resource, consistent COT structure information should be transmitted by another UE which shares the COT. For example, referring to FIG. 2, if UE #2A uses slot n+2 for transmitting a PSCCH and a PSSCH, UE #2A may transmit slot format combination 5.

FIG. 3 illustrates a flow chart of exemplary procedure 300 for sidelink communication over an unlicensed spectrum in accordance with some embodiments of the present disclosure. Details described in all of the foregoing embodiments of the present disclosure are applicable for the embodiments shown in FIG. 3. In some examples, the procedure may be performed by a UE, for example, UE 110 in FIG. 1.

Referring to FIG. 3, in operation 311, a UE may perform a channel access procedure for initiating a COT. In operation 313, the UE may transmit an SCI format within the COT in response to the channel access procedure being successful, wherein the SCI format may include structure information of the COT. The SCI format may or may not schedule a corresponding PSSCH within the COT.

In some embodiments, the SCI format may be transmitted within the COT according to a period. In some examples, the period may be configured by a serving BS or predefined. In some examples, the UE may transmit the period to another UE.

In some embodiments, the UE may determine the structure information of the COT based on at least one of: the transmission periodicity of the SCI format indicating COT structure information, a duration of a maximum channel occupancy time (MCOT) corresponding to the channel access procedure; a maximum number of slots within the MCOT; a processing capability for PSFCH transmission; a duration of resources shared with another UE; or a number of symbols within a gap.

In some embodiments, the structure information of the COT may indicate at least one of the following: a first time domain resource reserved for a PSFCH transmission, a second time domain resource occupied by the UE, a third time domain resource for a gap, a fourth time domain resource shared with another UE, or a fifth time domain resource for AGC.

In some embodiments, the UE may transmit a PSSCH on the second time domain resource. The PSSCH may or may not be scheduled by the SCI format. In some embodiments, the UE may receive a PSFCH on the first time domain resource carrying HARQ-ACK feedback corresponding to the PSSCH.

In some embodiments, the SCI format may include a COT structure indicator to indicate the structure information of the COT. The COT structure indicator may indicate a slot format combination from a list of slot format combinations or may indicate a COT structure from a list of COT structures.

In some embodiments, each slot format combination of the list of slot format combinations may include slot format information for one or more consecutive slots with respect to a reference sub-carrier spacing (SCS). In some embodiments, the slot format information for a slot may indicate a corresponding symbol state for each symbol of the slot. The corresponding symbol state may indicate at least one of the following: occupied by the UE, reserved for a PSFCH transmission, used for a gap, shared with another UE, or used for AGC.

In some embodiments, each COT structure of the list of COT structures may include at least one of the following indicators with respect to a reference SCS: a first indicator indicating a number of consecutive slots occupied by the UE; a second indicator indicating a number of symbols used as a gap within the last slot occupied by the UE; a third indicator indicating a number of consecutive slots shared with another UE (denoted as “second UE” for clarity); a fourth indicator indicating a number of symbols shared with the second UE within the last slot shared with the second UE; a fifth indicator indicating a number of symbols used as a gap between the end of the symbols shared with the second UE and the beginning of a first PSFCH unit of at least one PSFCH unit; a sixth indicator indicating a number of PSFCH units of the at least one PSFCH unit after the last symbol shared with the second UE; or a seventh indicator indicating the number of symbols after the last PSFCH unit of the at least one PSFCH unit.

In some embodiments, each of the at least one PSFCH unit may include a plurality of consecutive symbols for a PSFCH transmission. The first symbol of the plurality of consecutive symbols may be a repetition of the second symbol of the plurality of consecutive symbols.

In some embodiments, a gap may be between every two consecutive PSFCH units of the at least one PSFCH unit and may have a duration based on the fifth indicator.

In some embodiments, a number of slots within an MCOT corresponding to the channel access procedure is an integer multiple of number of slots within the indicated slot format combination or indicated COT structure.

In some embodiments, a bit size of the COT structure indicator is based on the number of slot format combinations in the list of slot format combinations or the number of COT structures in the list of COT structures.

In some embodiments, the list of slot format combinations or the list of COT structures is configured by a serving BS or predefined.

In some embodiments, the structure information of the COT may be structure information of the whole COT. The SCI format may indicate a position of a slot where the SCI format is transmitted with reference to a first slot of the COT. In some other embodiments, the structure information of the COT may be structure information of a remaining duration of the COT. In some embodiments, the position may be indicated by a slot index of the slot where the SCI format is transmitted with reference to the first slot of the COT. In some embodiments, the position may be indicated by a remaining duration of the COT. In yet other embodiments, the structure information of the COT is structure information within a corresponding transmission periodicity of the SCI format.

It should be appreciated by persons skilled in the art that the sequence of the operations in exemplary procedure 300 may be changed and some of the operations in exemplary procedure 300 may be eliminated or modified, without departing from the spirit and scope of the disclosure.

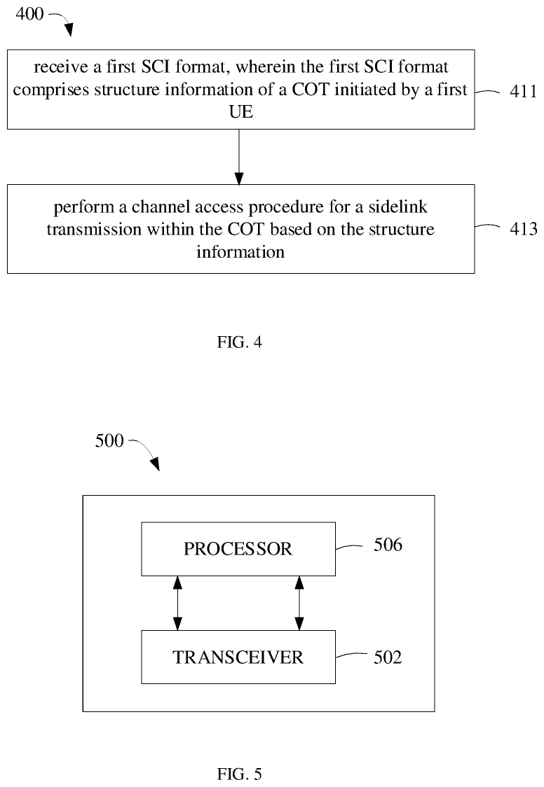

FIG. 4 illustrates a flow chart of an exemplary procedure 400 for wireless communications in accordance with some embodiments of the present disclosure. Details described in all of the foregoing embodiments of the present disclosure are applicable for the embodiments shown in FIG. 4. In some examples, the procedure may be performed by a UE, for example, UE 110 in FIG. 1.

Referring to FIG. 4, in operation 411, a UE may receive an SCI format (denoted as “first SCI format” for clarity), wherein the first SCI format may include structure information of a COT initiated by another UE (denoted as “first UE” for clarity). In operation 413, the UE may perform a channel access procedure for a sidelink transmission within the COT based on the structure information.

In some embodiments, the structure information of the COT may indicate at least one of the following: a first time domain resource reserved for a PSFCH transmission, a second time domain resource occupied by the first UE, a third time domain resource for a gap, a fourth time domain resource shared with the UE or another UE (denoted as “second UE” for clarity), or a fifth time domain resource for AGC.

In some embodiments, the UE may receive a PSSCH from the first UE on the second time domain resource or from the second UE on the fourth time domain resource. In some embodiments, performing a channel access procedure for a sidelink transmission may include performing a channel access procedure (e.g., LBT Cat.2) for transmitting a PSFCH on the first time domain resource carrying HARQ-ACK feedback corresponding to the PSSCH.

In some embodiments, performing a channel access procedure for a sidelink transmission may include performing a channel access procedure (e.g., LBT Cat.2) for transmitting a PSCCH and a PSSCH scheduled by the PSCCH on the fourth time domain resource. In some embodiments, the UE may transmit a second SCI format on the fourth time domain resource in response to the channel access procedure for the sidelink transmission being successful. The second SCI format may indicate the structure information of the COT.

In some embodiments, the first SCI format may be received within the COT according to a period. The period may be configured by a serving base station (BS), the first UE, or predefined.

In some embodiments, the first SCI format may include a COT structure indicator to indicate the structure information of the COT. The COT structure indicator may indicate a slot format combination from a list of slot format combinations or may indicate a COT structure from a list of COT structures.

In some embodiments, each slot format combination of the list of slot format combinations may include slot format information for one or more consecutive slots with respect to a reference sub-carrier spacing (SCS). In some embodiments, the slot format information for a slot may indicate a corresponding symbol state for each symbol of the slot. The corresponding symbol state may indicate at least one of the following: occupied by the first UE, reserved for a PSFCH transmission, used for a gap, shared with the UE or another UE, or used for AGC.

In some embodiments, each COT structure of the list of COT structures may include at least one of the following indicators with respect to a reference SCS: a first indicator indicating a number of consecutive slots occupied by the first UE; a second indicator indicating a number of symbols used as a gap within the last slot occupied by the first UE; a third indicator indicating a number of consecutive slots shared with the UE or another UE (denoted as “second UE” for clarity); a fourth indicator indicating a number of symbols shared with the UE or the second UE within the last slot shared with the UE or the second UE; a fifth indicator indicating a number of symbols used as a gap between the end of the symbols shared with the UE or the second UE and the beginning of a first PSFCH unit of at least one PSFCH unit; a sixth indicator indicating a number of PSFCH units of the at least one PSFCH unit after the last symbol shared with the UE or the second UE; or a seventh indicator indicating the number of symbols after the last PSFCH unit of the at least one PSFCH unit.

In some embodiments, each of the at least one PSFCH unit may include a plurality of consecutive symbols for a PSFCH transmission. The first symbol of the plurality of consecutive symbols may be a repetition of the second symbol of the plurality of consecutive symbols.

In some embodiments, a gap may be between every two consecutive PSFCH units of the at least one PSFCH unit and have a duration based on the fifth indicator.

In some embodiments, a bit size of the COT structure indicator may be based on the number of slot format combinations in the list of slot format combinations or the number of COT structures in the list of COT structures.

In some embodiments, the list of slot format combinations or the list of COT structures may be configured by a serving BS or predefined.

In some embodiments, the structure information of the COT may be structure information of the whole COT. The SCI format further may indicate a position of a slot where the SCI format is received with reference to a first slot of the COT. In some other embodiments, the structure information of the COT may be structure information of a remaining duration of the COT. In some examples, the position may be indicated by a slot index of the slot where the SCI format is received with reference to the first slot of the COT. In some examples, the position may be indicated by a remaining duration of the COT. In yet other embodiments, the structure information of the COT is structure information within a corresponding transmission periodicity of the SCI format.

It should be appreciated by persons skilled in the art that the sequence of the operations in exemplary procedure 400 may be changed and some of the operations in exemplary procedure 400 may be eliminated or modified, without departing from the spirit and scope of the disclosure.

FIG. 5 illustrates a block diagram of an exemplary apparatus 500 according to some embodiments of the present disclosure. As shown in FIG. 5, the apparatus 500 may include at least one processor 506 and at least one transceiver 502 coupled to the processor 506. The apparatus 500 may be a UE or a BS.

Although in this figure, elements such as the at least one transceiver 502 and processor 506 are described in the singular, the plural is contemplated unless a limitation to the singular is explicitly stated. In some embodiments of the present application, the transceiver 502 may be divided into two devices, such as a receiving circuitry and a transmitting circuitry. In some embodiments of the present application, the apparatus 500 may further include an input device, a memory, and/or other components.

In some embodiments of the present application, the apparatus 500 may be a UE. The transceiver 502 and the processor 506 may interact with each other so as to perform the operations with respect to the UEs described above, for example, in FIGS. 1-4.

In some embodiments of the present application, the apparatus 500 may be a BS. The transceiver 502 and the processor 506 may interact with each other so as to perform the operations with respect to the BSs described above, for example, in FIGS. 1-4.

In some embodiments of the present application, the apparatus 500 may further include at least one non-transitory computer-readable medium. For example, in some embodiments of the present disclosure, the non-transitory computer-readable medium may have stored thereon computer-executable instructions to cause the processor 506 to implement the method with respect to the UEs as described above. For example, the computer-executable instructions, when executed, cause the processor 506 interacting with transceiver 502 to perform the operations with respect to the UEs described in FIGS. 1-4.

For example, in some embodiments of the present disclosure, the non-transitory computer-readable medium may have stored thereon computer-executable instructions to cause the processor 506 to implement the method with respect to the BSs as described above. For example, the computer-executable instructions, when executed, cause the processor 506 interacting with transceiver 502 to perform the operations with respect to the BSs described in FIGS. 1-4.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

Please make the following amendments to the claims:

1. A user equipment (UE), comprising:
at least one memory; and
at least one processor coupled with the at least one memory and configured to cause the UE to:
perform a channel access procedure for initiating a channel occupancy time (COT); and
transmit a sidelink control information (SCI) format within the COT in response to the channel access procedure being successful, wherein the SCI format comprises structure information of the COT.

2. The UE of claim 1, wherein the structure information of the COT indicates at least one of the following:
a first time domain resource reserved for a physical sidelink feedback channel (PSFCH) transmission, a second time domain resource occupied by the UE, a third time domain resource for a gap, a fourth time domain resource shared with a second UE, or a fifth time domain resource for automatic gain control (AGC).

3. The UE of claim 1, wherein the SCI format is transmitted within the COT according to a period; and
wherein the period is configured by a serving base station or predefined; or the at least one processor is further configured to cause the UE to transmit the period.

4. The UE of claim 2, wherein the at least one processor is configured to cause the UE to:
transmit a physical sidelink shared channel (PSSCH) on the second time domain resource; and
receive a PSFCH on the first time domain resource carrying hybrid automatic repeat request acknowledge (HARQ-ACK) feedback corresponding to the PSSCH.

5. The UE of claim 1, wherein the SCI format comprises a COT structure indicator to indicate the structure information of the COT, and the COT structure indicator indicates a slot format combination from a list of slot format combinations or indicates a COT structure from a list of COT structures.

6. The UE of claim 1, wherein the at least one processor is further configured to cause the UE to determine the structure information of the COT based on at least one of:
a transmission periodicity of the SCI) format;
a duration of a maximum channel occupancy time (MCOT) corresponding to the channel access procedure;
a maximum number of slots within the MCOT;
a processing capability for PSFCH transmission;
a duration of resources shared with a second UE; or
a number of symbols within a gap.

7. The UE of claim 5, wherein each slot format combination of the list of slot format combinations comprises slot format information for one or more consecutive slots with respect to a reference sub-carrier spacing (SCS).

8. The UE of claim 7, wherein the slot format information for a slot indicates a corresponding symbol state for each symbol of the slot and the corresponding symbol state indicates at least one of the following:
occupied by the UE, reserved for a PSFCH transmission, used for a gap, shared with a second UE, or used for automatic gain control (AGC).

9. The UE of claim 5, wherein each COT structure of the list of COT structures comprises at least one of the following indicators with respect to a reference sub-carrier spacing (SCS):
a first indicator indicating a number of consecutive slots occupied by the UE;
a second indicator indicating a number of symbols used as a gap within the last slot occupied by the UE;
a third indicator indicating a number of consecutive slots shared with a second UE;
a fourth indicator indicating a number of symbols shared with the second UE within the last slot shared with the second UE;
a fifth indicator indicating a number of symbols used as a gap between the end of the symbols shared with the second UE and the beginning of a first PSFCH unit of at least one PSFCH unit;
a sixth indicator indicating a number of PSFCH units of the at least one PSFCH unit after the last symbol shared with the second UE; or
a seventh indicator indicating the number of symbols after the last PSFCH unit of the at least one PSFCH unit.

10. The UE of claim 5, wherein a number of slots within a maximum channel occupancy time (MCOT) corresponding to the channel access procedure is an integer multiple of number of slots within the indicated slot format combination or indicated COT structure.

11. The UE of claim 1, wherein the structure information of the COT is structure information of the whole COT, and the SCI format indicates a position of a slot where the SCI format is transmitted with reference to a first slot of the COT; or
wherein the structure information of the COT is structure information of a remaining duration of the COT; or
wherein the structure information of the COT is structure information within a corresponding transmission periodicity of the SCI format.

12. The UE of claim 11, wherein the position is indicated by a slot index of the slot where the SCI format is transmitted with reference to the first slot of the COT, or the position is indicated by a remaining duration of the COT.

13. A user equipment (UE), comprising:
at least one memory; and
at least one processor coupled with the at least one memory and configured to cause the UE to:
receive a first sidelink control information (SCI) format, wherein the first SCI format comprises structure information of a channel occupancy time (COT) initiated by a first UE; and
perform a channel access procedure for a sidelink transmission within the COT based on the structure information.

14. The UE of claim 13, wherein the structure information of the COT indicates at least one of the following:
a first time domain resource reserved for a physical sidelink feedback channel (PSFCH) transmission,
a second time domain resource occupied by the first UE,
a third time domain resource for a gap,
a fourth time domain resource shared with the UE or a second UE, or
a fifth time domain resource for automatic gain control (AGC).

15. A method performed by a user equipment (UE), the method comprising:
performing a channel access procedure for initiating a channel occupancy time (COT); and
transmitting a sidelink control information (SCI) format in response to the channel access procedure being successful, wherein the SCI format comprises structure information of the COT.

16. The method of claim 15, wherein the structure information of the COT indicates at least one of the following:
a first time domain resource reserved for a physical sidelink feedback channel (PSFCH) transmission, a second time domain resource occupied by the UE, a third time domain resource for a gap, a fourth time domain resource shared with a second UE, or a fifth time domain resource for automatic gain control (AGC).

17. The method of claim 15, wherein the SCI format is transmitted within the COT according to a period; and
wherein the period is configured by a serving base station or predefined; or the method further comprises transmitting the period.

18. The method of claim 17, wherein the method further comprises:
transmitting a physical sidelink shared channel (PSSCH) on the second time domain resource; and
receiving a PSFCH on the first time domain resource carrying hybrid automatic repeat request acknowledge (HARQ-ACK) feedback corresponding to the PSSCH.

19. The method of claim 15, wherein the SCI format comprises a COT structure indicator to indicate the structure information of the COT, and the COT structure indicator indicates a slot format combination from a list of slot format combinations or indicates a COT structure from a list of COT structures.

20. A method performed by a user equipment (UE), the method comprising:
receiving a first sidelink control information (SCI) format, wherein the first SCI format comprises structure information of a channel occupancy time (COT) initiated by a first UE; and
performing a channel access procedure for a sidelink transmission within the COT based on the structure information.
